(19) United States
(12) Patent Application Publication
(10) Pub. No.: US 2008/0250349 A1
(43) Pub. Date: Oct. 9, 2008

(54) Graphical user interface

(75) Inventors: Josep Abad Peiro, Barcelona (ES); Thierry Dupasquier, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/783,023

(22) Filed: Apr. 5, 2007

(51) Int. Cl. G06F 3/048

(52) U.S. Cl. 715/810

(57) ABSTRACT

A graphical user interface for controlling a printer application is presented. The interface comprises a first menu having a first set of selectable options; and a second menu concentrically-disposed relative to the first menu, the second menu having a second set of selectable options which are hierarchically related to the first set of selectable options. A selectable option is selected by positioning selection means within a region associated with the selectable option. When a selectable option of the first set is selected, a selectable option of the second set having a hierarchical relationship with the selected option of the first set is displayed.

### FIELD OF THE INVENTION

This invention relates to field of graphical user interfaces, and more particularly to graphical user interfaces for controlling a printer.

### BACKGROUND

To operate a printer, a user needs to be able to asses and control a state of the printer. Typically, a user interface is employed to provide such functionality and comprises graphical, textual and/or auditory information which is presented to a user. Using this presented information, the user can then employ control sequences (such as keystrokes with a computer keyboard, movements of a computer mouse, and/or selections with a touch-screen) to control the printer (or an associated program).

Graphical user interfaces (GUI) typically accept user inputs via devices, such as a computer keyboard and mouse, and provide a graphical output to the user via a display. The visible graphical elements of a GUI that may be used to control a program/device are known as widgets. Common widgets include: windows, buttons, menus, and scroll bars.

The design of a GUI is an important consideration since it can have a direct impact on the usability of the device it is being used to control, in addition to potentially affecting the underlying design of the device. Particular effort has therefore been focused upon the design of menus in an attempt to make them easy to use and/or capable of presenting multiple options in an efficient manner.

In the field of printing, printers are typically controlled using a “panel-like” GUI that includes buttons and “drop-down” menus. Unfortunately, such panel-like GUIs typically provide a user with predetermined set of options arranged in a clustered or grouped manner, and are limited in the amount of user options that they can display at once. Thus, a user is required to break their creative focus from one task and adapt their focus to select from multiple options that are presented to them simultaneously, thereby detracting from a creative state of mind that the user may have attained.

GUIs for controlling printers are generally also difficult to use since they can present a user with a confusing array of options which are arranged in a predetermined and/or restrictive manner.

Accordingly, it is desirable to develop a simple and intuitive GUI for controlling a printing device that aims not to distract a user from a creative process that they may be undertaking. Further, it is preferable that such a GUI make efficient uses of display space.

### BRIEF DESCRIPTION OF THE DRAWINGS

For a better understanding of the invention, embodiments will now be described, purely by way of example, with reference to the accompanying drawings, in which:

FIG. 1 shows a graphical user interface according to an embodiment of the invention;

FIGS. 2a to 2d illustrate an exemplary operation of a graphical user interface according to an embodiment of the invention; and

FIG. 3 shows an exemplary implementation of a graphical user interface according to an embodiment of the invention.

### DETAILED DESCRIPTION OF THE INVENTION

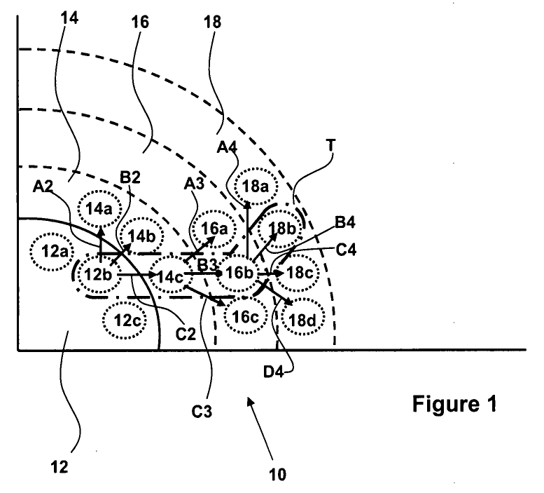

Referring to FIG. 1, a graphical user interface (GUI) for controlling a printer application according an embodiment of the invention comprises a first menu 12 and a second menu 14. The GUI 10 is displayed on suitable display means, such as a display screen of a personal computer (PC), printing device, personal digital assistant (PDA), or any other suitable device that has a display and may be used to control a printing device.

The first menu 12 has a first set of first 12a to third 12c selectable options and is shaped generally as a portion of a circle, wherein the selectable options 12a to 12c of the first set are positioned within the first menu 12 such that they are spaced apart from each other.

The second menu 14 is concentrically-disposed relative to the first menu 12, and has a second set of first 14a to third 14c selectable options which are hierarchically related to the first set of selectable options 12a to 12c. More specifically, in the illustrated example, the second set of selectable options 14a to 14c are all hierarchically related to the second selectable option 12b of the first menu 12 such that they are sub-options of the second selectable option 12b of the first menu 12.

Each selectable option of the first 12 and second 14 menus has an associated selection region (as indicated by the dotted lines). When suitable selection means (such as a pointer, cursor or stylus, for example) are positioned within a selection region, the selectable option that is associated with that selection region is said to be selected. Further, the selectable options may comprise a text description, an image, an animation, and/or any other suitable means for conveying information regarding the corresponding option.

As illustrated in FIG. 1, when the second selectable option 12b of the first menu 12 is selected, the second set of selectable options 14a to 14c (which are sub-options of the second selectable option 12b of the first menu 12) is automatically displayed. A user then has the option of selecting any of the second set of selectable options 14a to 14c by moving the selection means in the appropriate direction (as generally indicated by the arrows labeled “A2”, “B2” and “C2”).

The embodiment of FIG. 1 also comprises a third menu 16 and a fourth menu 16, both of which are concentrically-disposed relative to the first menu 12.

The third menu 16 comprises a third set of first 16a to third 16c selectable options which are hierarchically related to the second set of selectable options 14a to 14c. In the illustrated example, the third set of selectable options 16a to 16c are all hierarchically related to the third selectable option 14c of the second menu 14 such that they are sub-options of the third selectable option 14c of the second menu 14. Similarly to those of the first 12 and second 14 menus, each selectable option of the third 14 menu has an associated selection region (as indicated by the dotted lines).

As illustrated in FIG. 1, after selecting second selectable option 12b of the first menu 12, a user moves the selection means in the direction indicated by arrow C2 in order to select the third selectable option 14c of the second menu 14.

In similar fashion to that already described for selecting an option in the first menu 12, when the third selectable option 14c of the second menu 14 is selected, the third set of selectable options 16a to 16c (which are sub-options of the third selectable option 14c of the second menu 14) is automatically displayed. A user then has the option of selecting any of the third set of selectable options 16a to 16c by moving the selection means in the appropriate direction (as generally indicated by the arrows labeled “A3”, “B3” and “C3”).

The fourth menu 18 comprises a fourth set of first 18a to fourth 18d selectable options which are hierarchically related to the third set of selectable options 16a to 16c. In the illustrated example, the fourth set of selectable options 18a to 18c are all hierarchically related to the second selectable option 16b of the second menu 16 such that they are sub-options of the second selectable option 16b of the third menu 16. Similarly to those of the first 12, second 14 and third 18 menus, each selectable option of the fourth 14 menu has an associated selection region (as indicated by the dotted lines).

As illustrated in FIG. 1, after selecting the second selectable option 12b of the first menu 12, and subsequently selecting the third selectable option 14c of the second menu 14, the user moves the selection means in the direction indicated by arrow B3 in order to select the second selectable option 16b of the third menu 16.

When the second selectable option 16b of the third menu 16 is selected, the fourth set of selectable options 18a to 18d (which are sub-options of the second selectable option 16b of the third menu 16) is automatically displayed. A user then has the option of selecting any of the fourth set of selectable options 18a to 18d by moving the selection means in the appropriate direction (as generally indicated by the arrows labeled “A4”, “B4”, “C4” and “D4”).

In the example illustrated in FIG. 1, the user moves the selection means in the direction indicated by arrow B4 in order to select the second selectable option 18b of the fourth menu 18. Thus, in FIG. 1, a user has selected the second selectable option 18b of the fourth menu 18, after having completed the process of selecting the second selectable option 12b of the first menu 12, then selecting the third selectable option 14c of the second menu 14, and then selecting the second selectable option 16b of the third menu 16.

It will therefore be appreciated that the selection means have been maneuvered along a path of travel as illustrated by the dash-dotted region labeled “T”, from one end within the area of the first menu to the other end within the area of the fourth menu. This path of travel T describes a smooth, intuitive movement of the selection means that can be adapted to follow a thought process of a user. By defining the menus and/or selectable options so that their hierarchical relationships represent the process flow(s) of one or more procedures for controlling a printing device, the GUI can present selectable options in an intuitive manner, expanding and contracting menus so that they are made visible/invisible as appropriate.

“Flow” is a state of creation as defined by author and psychologist Mihaly Csikszentmihalyi. When in a mental state of a flow, a user/creator is generally immersed in what he or she is doing, and this is characterized by a feeling of energized focus, involvement, and success in the process of the activity. By employing flow-based principles, a GUI according to the invention reduces the possibility that the creative focus of a user is disturbed. By replicating a thought process within the hierarchical relationships of the menus and/or the selectable options of the GUI, a user can interact and/or use the GUI intuitively and, therefore, the user experience may be improved.

Of course, it will be understood that the first and second menus are not restricted to being represented as only part of a circle, but instead may comprise a whole circle or oval shape. Furthermore, the menus may be polygonal rather than curvilinear and need not be the same shape as each other.

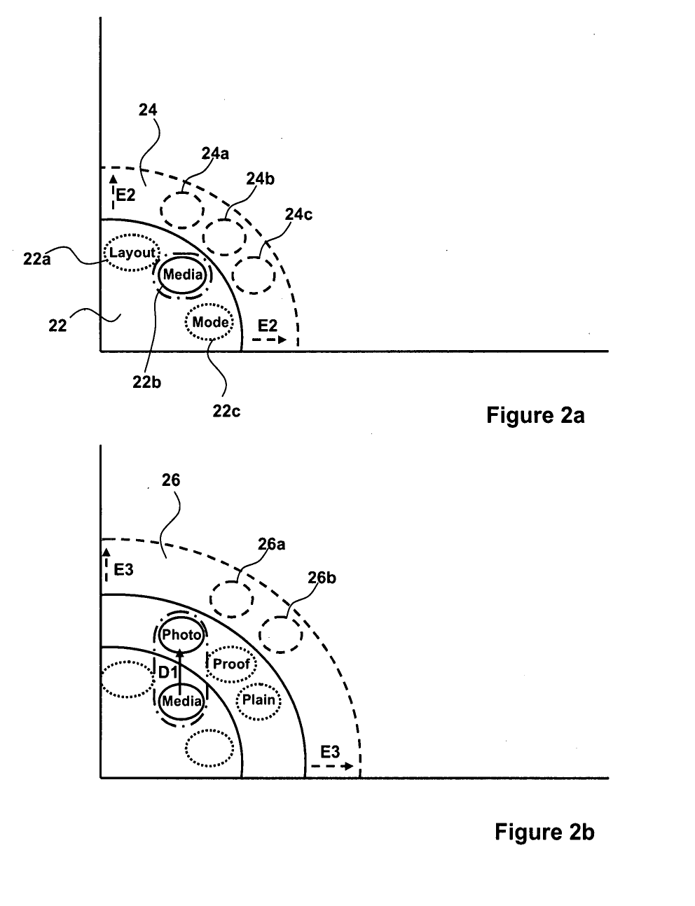

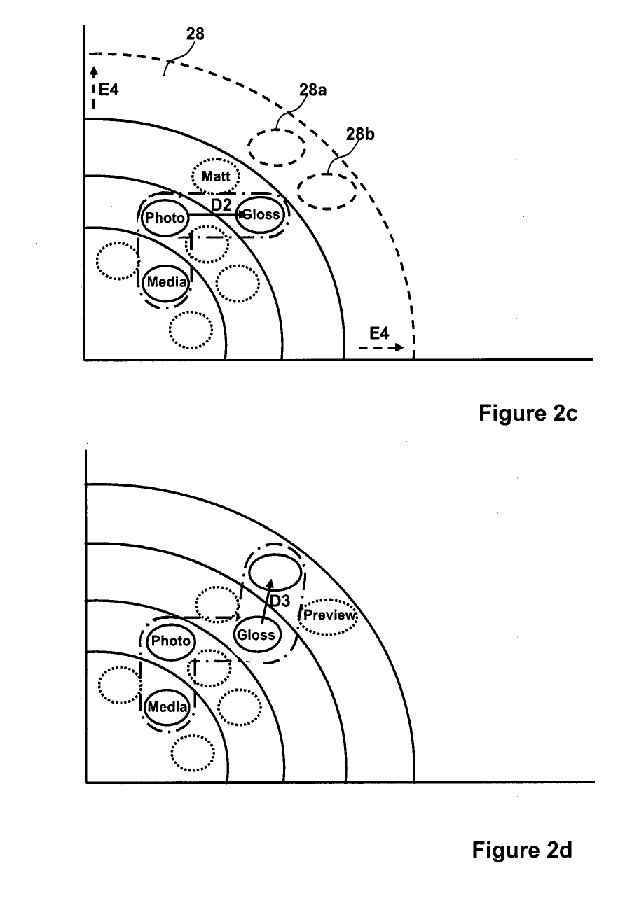

Referring now to FIGS. 2a to 2d, an exemplary operation of a GUI according to an embodiment of the invention will now be described. The GUI 20 is displayed on suitable display means, such as a display screen of a personal computer (PC), and may be used to control a printing device.

As illustrated in FIG. 2a, a first menu 22 is displayed at the lower left of the display mean, wherein the first menu 22 is circular shaped with the centre of the circle corresponding generally to the lower left corner of the display such that the first menu 22 is displayed as a quarter of a circle.

The first menu 22 includes a first set of selectable options 22a to 22c corresponding to various functions or options for a printing device or the like. In the illustrated example of FIG. 2a, the first set of selectable options 12a to 12c correspond to top-level options for a printer, e.g. “Layout”, “Media” and “Mode”. Of course, other functions and/or options may be provided within the first menu 22.

Each selectable option of the first 22 menu has an associated selection region (as indicated by the oval shapes). When suitable selection means (such as a pointer or stylus, for example) are positioned within a selection region, the selectable option that is associated with that selection region is said to be selected.

As illustrated in FIG. 2a, a user selects the second selectable option 22b of the first menu 22 using an appropriate input device such as a keyboard, mouse, remote control or stylus. Upon selection of the second selectable option 22b, a second menu 24 is automatically displayed by means of an appropriate visual effect. In the illustrated example, the second menu 24 is concentrically-disposed relative to the first menu 22 and expands from its centre so as to have radius that is greater than that of the first menu 22 in order to be displayed. For a better understanding, the movement of the second menu 24 due to such an expansion effect is indicated generally by the arrows labeled “E2”.

Thus, the second menu 24 is arranged so that is not visible to a user when none of the selectable options in the first menu 22 are selected.

When displayed due to the second selectable option 22b of the first menu 22 being selected, the second menu comprises a second set of selectable options 24a to 24c which are hierarchically related to the first set of selectable options 22a to 22c. More specifically, in FIG. 2a, the second set of selectable options 24a to 24c is hierarchically related to the second selectable option 22b of the first menu 22 such that they are sub-options of the second selectable option 22b of the first menu 22.

Thus, as shown in FIG. 2b, the user then has the option of selecting any of the second set of selectable options 24a to 24c by moving the selection means in the appropriate direction. In this example, the second set of selectable options 24a to 24c corresponds to sub-options of the “Media” option of a printer, e.g. “Photo”, “Proof” and “Plain”. As before, other functions and/or options may be provided within the second menu 24, wherein the specific options displayed in the second menu 24 are dependent upon which selectable option of the first menu 22 is selected by the user.

As illustrated in FIG. 2b, a user then selects the first selectable option 24a of the second menu 24 by moving the selection means in an appropriate direction (as generally indicated by the arrow labeled “D1). Upon selection of the first selectable option 24a of the second menu 24, a third menu 26 is automatically displayed by means of an appropriate visual effect. More specifically, the third menu 24 is concentrically-disposed relative to the first 22 and second 24 menus and expands from its centre so as to have radius that is greater than that of the first 22 and second 24 menus in order to be displayed. Similarly to the expansion effect for the second menu 24, the movement of the third menu 26 due to such an expansion effect is indicated generally by the arrows labeled “E3”.

When displayed due to the first selectable option 24a of the second menu 24 being selected, the third menu 26 displays a third set of selectable options 26a to 26b which are hierarchically related to the first 22 and second 24 menus. More specifically, in FIG. 2b, the third set of selectable options 26a and 26b is hierarchically related to the first selectable option 24a of the second menu 24 such that they are sub-options of first selectable option 24a of the second menu 24.

Accordingly, as shown in FIG. 2c, the user then has the option of selecting any of the third set of selectable options 26a and 26b by moving the selection means in the appropriate direction. In this example, the third set of selectable options 26a and 26b corresponds to sub-options of the “Photo” option of a printer, e.g. “Matt” and “Gloss”. As before, other functions and/or options may be provided within the third menu 24, wherein the specific options displayed in the third menu 24 are dependent upon which selectable option of the first 22 and/or second menu 24 is selected by the user.

The user then selects the second selectable option 26b of the third menu 26 by moving the selection means in an appropriate direction (as generally indicated by the arrow labeled “D2). Upon selection of the second selectable option 26b of the second menu 26, a fourth menu 28 is automatically displayed by means of an appropriate visual effect. As for the previously described second and third menus, the fourth menu 28 is concentrically-disposed relative to the first menu 22. In order to be displayed, the fourth menu expands from its centre so as to have radius that is greater than that of the first 22, second 24 and third 26 menus. Similarly to the expansion effect for the second 24 and third 26 menus, the movement of the fourth menu 28 due to such an expansion effect is indicated generally by the arrows labeled “E4”.

When displayed due to the second selectable option 26b of the third menu 26 being selected, the fourth menu 28 displays a fourth set of selectable options 28a to 28b which are hierarchically related to the third menu 26 (and therefore also hierarchically related the first 22 and second 24 menus). More specifically, the fourth set of selectable options 28a and 28b is hierarchically related to the second selectable option 26b of the third menu 26 such that they are sub-options of second selectable option 26b of the third menu 26.

Thus, as shown in FIG. 2d, the user then has the option of selecting any of the fourth set of selectable options 28a and 28b by moving the selection means in the appropriate direction. In this example, the fourth set of selectable options 28a and 28b corresponds to sub-options of the “Gloss” option of a printer, e.g. “Print” and “Preview”.

The user then selects the first selectable option 28a of the fourth menu 28 by moving the selection means in an appropriate direction (as generally indicated by the arrow labeled “D3).

The first selectable option 28a of the fourth menu 28 is the final option is the hierarchy and therefore its selection does not cause a further menu to be displayed. Instead, the first selectable option 28a of the fourth menu 28 is associated with a set of instructions that may be executed when it is selected. As with the previous selectable options, selection of the first selectable option 28a of the fourth menu 28 by simply positioning the selection means within the selection region of the first selectable option may automatically cause the set of instructions to be executed. However, alternative embodiments may be arranged so that a final option in a hierarchy requires activation before an associated set of instruction is executed. For example, such activation may comprise the user performing a predetermined action while the option is selected, e.g. pressing an “confirm” button on an appropriate input device such as a keyboard, mouse, remote control or stylus.

The set of instructions may therefore comprise appropriate computer program code that configures and/or controls a printing device associated with the GUI.

Although not specifically illustrated in FIGS. 2a-2d, the second set of selectable options provided by the second menu 22 may comprise first and second subsets of the selectable options. The first subset of selectable options may be hierarchically related to a first selectable option 22a in the first menu 22, whereas the second subset of selectable options may be hierarchically related to a second selectable option 22b in the first menu 22. The GUI may then be arranged such that when the first selectable option 22a in the first menu is selected, the first subset of selectable options in the second menu 24 is displayed and/or activated for possible selection by a user, while the second subset of selectable options in the second menu 24 is not displayed and/or not activated for selection by a user. Conversely, when the second selectable option 22b in the first menu 22 is selected, the first subset of selectable options in the second menu 24 may be not displayed and/or not activated for selection, while the second subset of selectable options in the second menu 24 is displayed and/or activated for possible selection by a user.

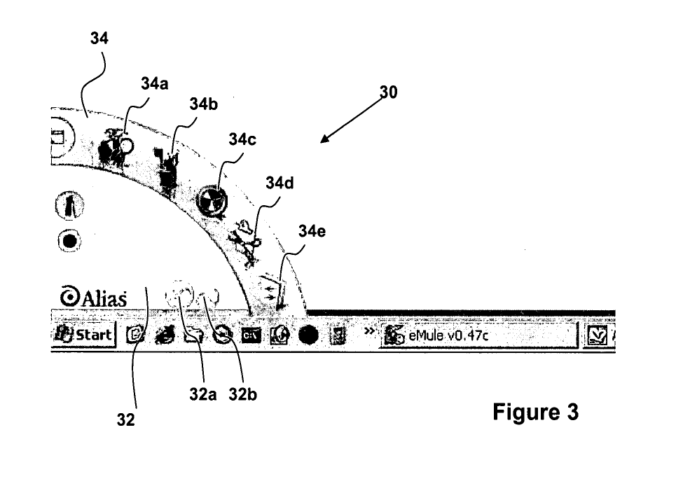

Referring to FIG. 3, an exemplary implementation of a GUI according to the invention is shown.

The GUI 30 comprises a first menu 32 and a second menu 34 and is displayed at the lower-left corner of a WINDOWS® desktop.

The first menu 32 has a first set of first 32a and second 32b selectable options and is shaped generally as a quarter of a circle. The selectable options 32a and 32b are displayed as icons which convey information regarding the options they represent.

The second menu 34 is curvilinear and generally ring-shaped so that is adjoins the curved edge of the first menu 32. In other words, the second menu 34 could be a quarter of a circle, wherein the circle has a greater radius than that of the first menu, and concentrically positioned with respect to the first menu 32. The second menu 34 has first 34a to fifth 34e selectable options circumferentially disposed along its curved edge so that they are visible around the curved edge of the first menu 32.

In response to a selection of an option in the second menu 34, a third curvilinear menu may be concentrically displayed which has further selectable options which may be hierarchically related to selectable options of the first 32 and/or second menu 34.

Also, in response to a selection of an option in the first menu 34, some or all of the menus of the GUI may be activated or inactivated.

By way of example, the menus and the respective selectable options shown in FIG. 3 are adapted as follows.

The first menu 32 is adapted to display a preview of a how document will look when it is printed by an associated printer. By default, the GUI 30 is arranged to automatically display an optimal or preferred option for a print media that is selected.

When selected and/or activated, the first selectable option 32a of the first menu 32 moves forward by a page in the document preview. Conversely, the second selectable option 32b of the first menu 32 moves the document preview backward one page when it is selected and/or activated.

The first 34a to fifth 34e selectable options in the second menu 34 provide enable a user to select and configure various options for the document and printer. The selectable options that are displayed in a third curvilinear menu in response to a selection of an option in the second menu 34, may be summarized as follows.

First selectable option 34a in the second menu 34=Document:
Scale to fit or scale to a percentage.
Select landscape or portrait
Print all document or selected pages.
Image quality (print modes)

Second selectable option 34b in the second menu 34=Paper:
Media type loaded
Install ICC Profile
Manage Papers
Calibration status for installed media
Calibrate the printer
Learn how to calibrate the display
More info from HP Printing knowledge center

Third selectable option 34c in the second menu=Information:
Status of the printer
Job management
Ink levels
Paper currently selected
Connectivity status
Statistics on usage
More info from HP Printing knowledge center

Fourth selectable option 34d in the second menu=Advanced options:
HP Professional Pantone Emulation
Digital Fine Arts Capture
More info from HP Printing knowledge center

Fifth selectable option 34e in the second menu=Support
More info from HP Printing knowledge center

It will be understood from the above description of the invention that any number of menus may be displayed, and that specific menus displayed at a particular instance may be dependent upon which selectable option is selected and/of what other selectable options have been selected prior to a selection at that instance.

Various visual effects may be applied to the menus in order to make them more visible when specific selection criteria are met. Alternatively, the menus may be adapted to move from an off-screen or invisible location as necessary. Such effects may add to the visual appeal of the GUI and/or make more efficient use of space available on the display means.

In specific embodiments, each of the menus may be displayed from the start, while only one of the menus (for example, the first menu 22) is initially active. By selecting an option provided by the first menu, a user may then cause a further menu (e.g. the second menu 24) to become active, and hence forth. Further, provision may be made for switching between menus without actually making a selection. Thus, in an alternative embodiment, the GUI may be adapted to display most or all of the available options. Such views may, of course, be customized to a user's specific preference. The invention therefore enables a user to interact with a GUI intuitively, thereby providing a unified experience that does not break an existing flow.

While specific embodiments have been described herein for purposes of illustration, various modifications will be apparent to a person skilled in the art and may be made without departing from the scope of the invention.

We claim:

1. A graphical user interface for controlling a printer application, the interface comprising:
a first menu having a first set of selectable options; and
a second menu concentrically-disposed relative to the first menu, the second menu having a second set of selectable options which are hierarchically related to the first set of selectable options,
wherein a selectable option is selected by positioning selection means within a region associated with the selectable option,
and wherein when a selectable option of the first set is selected, a selectable option of the second set having a hierarchical relationship with the selected option of the first set is displayed.

2. A graphical user interface according to claim 1, wherein at least one of the first and second menus is curved.

3. A graphical user interface according to claim 1, wherein the selectable options in the second set are sub-options of the selectable options in the first set.

4. A graphical user interface according to claim 1, wherein at least one selectable option comprises at least one of: a text description; an image; and an animation.

5. A graphical user interface according to claim 1, wherein at least one selectable option is associated with a set of instructions, and wherein the set of instructions is executed when the at least one selectable option is activated by a user performing a predetermined action while the option is selected.

6. A graphical user interface according to claim 5, wherein the set of instructions comprises computer program code.

7. A graphical user interface according to claim 1, wherein the second set of selectable options is not visible when none of the selectable options in the first set are selected.

8. A graphical user interface according to claim 1, wherein the second set of selectable options comprises:
a first subset of selectable options hierarchically related to a first selectable option in the first set of selectable options; and
a second subset of selectable options hierarchically related to a second selectable option in the first set of selectable options,
wherein when the first selectable option in the first set is selected, the first subset of selectable options is displayed and the second subset of selectable options is hidden, and wherein when the second selectable option in the first set is selected, the first subset of selectable options is hidden and the second subset of selectable options is displayed.

9. A method for obtaining a user input from a graphical user interface, the method comprising:
displaying a first menu having a first set of selectable options; and
receiving information regarding a selected option of the first set of selectable options,
in response to the received information, displaying a second menu concentrically-disposed relative to the first menu, the second menu having a second set of selectable options which are hierarchically related to the first set of selectable options.

10. A method according to claim 9, wherein the selectable options in the second set are sub-options of the selectable options in the first set.

11. A method according to claim 9, wherein at least one selectable option comprises at least one of: a text description; an image; and an animation.

12. A method according to claim 9, wherein at least one selectable option is associated with a set of instructions, and further comprising the steps of:
receiving an activation signal indicating that the at least one selectable has been activated by a user; and
executing the set of instructions.

13. A method according to claim 12, wherein the set of instructions comprises computer program code.

14. A method according to claim 9, wherein the second set of selectable options comprises:
a first subset of selectable options hierarchically related to a first selectable option in the first set of selectable options; and
a second subset of selectable options hierarchically related to a second selectable option in the first set of selectable options,
and the method further comprises the steps of:
when the first selectable option in the first set is selected by a user, displaying the first subset of selectable options and hiding the second subset of selectable options; and
when the second selectable option in the first set is selected by a user, hiding the first subset of selectable options and displaying the second subset of selectable options.

15. A computer program comprising computer program code means adapted to perform all of the steps of claim 9 when said computer program is run on a computer.

16. A computer program as claimed in claim 15 embodied on a computer readable medium.

17. A printing system comprising:
display means for displaying a graphical user interface;
a printing device; and
control means for configuring or controlling the printing device, wherein the display means is adapted to display a graphical user interface according to claim 1, and the control means is adapted to configure or control the printing device in response to a selection made using the graphical user interface.

18. A printing system comprising:
display means for displaying a graphical user interface;
a printing device; and
control means for configuring or controlling the printing device, wherein the display means is adapted to display a graphical user interface comprising:
a first menu having a first set of selectable options; and
a second menu concentrically-disposed relative to the first menu, the second menu having a second set of selectable options which are hierarchically related to the first set of selectable options,
wherein a selectable option is selected by positioning selection means within a region associated with the selectable option,
and wherein when a selectable option of the first set is selected, a selectable option of the second set having a hierarchical relationship with the selected option of the first set is displayed,
and the control means is adapted to configure or control the printing device in response to a selection made using the graphical user interface.
wherein the system is adapted to perform all of the steps of claim 9.
